(19) United States
(12) Patent Application Publication
(10) Pub. No.: US 2025/0283188 A1
(43) Pub. Date: Sep. 11, 2025

(54) METHOD FOR QUENCHING A RACK USING A GAS FLOW

(71) Applicant: JTEKT EUROPE, IRIGNY (FR)

(72) Inventor: Arnaud BERTONI, SAINT GENIS LAVAL (FR)

(73) Assignee: JTEKT EUROPE, IRIGNY (FR)

(21) Appl. No.: 19/070,941

(22) Filed: Mar. 5, 2025

(30) Foreign Application Priority Data
Mar. 5, 2024 (FR) 2402185

(51) Int. Cl. C21D 1/10; C21D 9/00

(52) U.S. Cl. CPC C21D 1/10; C21D 9/0062; C21D 9/0075

(57) ABSTRACT

A quenching method for a power steering rack of a vehicle, the method including: a heating step in which at least one zone to be treated of an outer surface of the rack is heated by means of an electric current induced in the zone; wherein the method comprises a cooling step in which the at least one zone is cooled by means of at least one first gas flow projected onto the zone.

### TECHNICAL FIELD

The invention concerns the field of methods for manufacturing a power steering rack, and more particularly a method for quenching said rack and a quenching device.

### STATE OF THE PRIOR ART

A vehicle steering system is intended to enable a driver to control a vehicle's trajectory by changing an angle of orientation of the vehicle's wheels by means of a steering wheel.

There are steering systems in which a variation in rotation of the vehicle wheels is carried out by a mechanical assembly composed of a steering pinion which meshes with a rack. The rack is slidably mounted in a longitudinal direction in a steering casing. The two ends of the rack, external to the casing, are coupled respectively to two steering connecting rods, which are themselves associated respectively with the left and right steered wheels of the vehicle.

The rack comprises on the one hand a toothing formed of teeth and, on the other hand, a toothing back opposite the toothing. The toothing extends in a longitudinal direction of the rack.

During the manufacturing of the rack, a quenching operation is carried out in order to harden the surface of said rack. More precisely, the quenching operation is a heat treatment which aims to transform the metal of the rack over a quenching thickness from an austenitic crystalline structure obtained during a heating step, into a martensitic crystalline structure.

There is a known method for carrying out this quenching which consists of generating electric currents in the rack, by induction or conduction, so as to increase the surface temperature, then placing the heated part in contact with water so as to rapidly cool the rack.

The disadvantage of such a method is that it requires a large quantity of water to be decontaminated and cooled, that it generates water vapor, that it uses additives in the water such as polymers, and that it causes distortion of the rack which may require the addition of a step to straighten said rack.

There is therefore a need for a quenching method that is particularly more environmentally friendly.

### DISCLOSURE OF THE INVENTION

One embodiment concerns a quenching method for a power steering rack of a vehicle, the method comprising:
A heating step in which at least one zone to be treated of an outer surface of the rack is heated by means of an electric current induced in said zone;

Characterized in that the method comprises:
A cooling step in which the at least one zone is cooled by means of at least one first gas flow projected onto said zone.

The quenching method consists in performing a heat treatment which aims to transform the metal of the rack over a quenching thickness. The heating step makes it possible to obtain an austenitic crystalline structure and then the cooling step makes it possible to transform the austenitic crystalline structure into a martensitic crystalline structure.

The rack comprises an outer surface to be treated. In other words, the rack comprises an outer surface whose crystalline structure must be modified over a quenching thickness which is preferably less than a total thickness of the rack.

Thus, an internal part of the rack, that is to say the part between the quenching thickness and a center of the rack, is not quenched, in other words, its crystalline structure is not modified. The internal part compresses the treated zone so as to create compressive stresses improving a fatigue resistance of the rack.

Furthermore, a transformation into martensite by quenching of the outer surface to be treated makes it possible to improve the surface hardness of the outer surface and thus increase the wear resistance of the rack.

The quenching method involves a heating step followed by a cooling step.

The heating step is carried out by means of an electric current induced in the zone to be treated. A temperature reached by the zone to be treated depends on the material of the zone to be treated. With certain grades of steel, the temperature of the zone to be treated is higher than 700° C., for example higher than 850° C., or 900° C.

The cooling step consists in reducing the temperature of the zone so as to transform the austenitic crystalline structure obtained during the heating step into the martensitic crystalline structure. To do this, a cooling rate of the zone must be at least equal to a martensitic critical rate. The martensitic critical rate is determined in the laboratory according to the material and more particularly according to the grade of the steel of the rack.

The method is innovative in that the cooling is performed by means of a first gas flow projected onto the zone. In other words, the gas flow is voluntarily directed at a determined flow rate, temperature and pressure onto the zone. The first gas flow is an artificially created flow to cool the zone.

Indeed, the applicant has found that it is possible to obtain, contrary to what is commonly accepted, a martensitic structure by cooling with a gas, that is to say with a fluid having a drasticity lower than that of water, for the quenching thickness commonly accepted for the racks, for example a few millimeters.

The drasticity corresponds to the cooling power of the fluid, that is to say an ability of the fluid to evacuate calories from a metal. The drasticity for a fluid is calculated by the formula:

$$H = \frac{α}{2 \cdot λ} \qquad [ Math 1 ]$$

With:
H: drasticity in mm−1
α: the exchange coefficient in W/m²K
λ: the thermal conductivity coefficient of the material to be cooled in W/mK

Using a gas during the cooling step allows a slower cooling than with water. Stresses exerted in the rack during the cooling step are therefore reduced as well as resulting deformations and cracks.

The method according to the invention is therefore less expensive than that of the state of the art in that it reduces the number of non-compliant racks due to the presence of excessive deformation or cracks.

Furthermore, the method according to the invention does not require the use of water, which will be partly evaporated, and which must be decontaminated and cooled, and of additives which can be partly burned when brought into contact with the hot rack and thus create potentially toxic fumes.

Finally, the use of a gas makes it possible to avoid pollution of the heating elements, such as inductors, leading to their degradation and replacement.

The subject of this disclosure may also exhibit one or more of the following characteristics, taken alone or in combination.

In some embodiments, at least one second gas flow is projected onto one end of the rack.

Thus, the second gas flow allows constant cooling of the rack, and in particular of the center of the rack. The cooling step is improved.

In some embodiments, an outlet pressure of a nozzle for projecting the first and/or second gas flow is comprised between 0.5 bar and 30 bar, for example between 1 bar and 20 bar, or greater than or equal to 1 bar, for example greater than 5 bar or 20 bar.

Thus the gas flow is projected under pressure so as to improve the drasticity of the gas and therefore the efficiency of the cooling step.

In some embodiments, the gas of the first or second gas flow is air, and/or at least one neutral gas.

The first or second gas flow can therefore also be a mixture of air and neutral gases, or a mixture of neutral gases.

Using air allows a particularly inexpensive and environmentally friendly cooling step in that the air does not need to be cooled, recycled or depolluted.

Using a neutral gas allows an improvement in the drasticity of the gas.

For example, the neutral gas can be selected from: nitrogen, helium, argon.

In some embodiments, during the heating step, the at least one zone is heated by induction of the electric current or by conduction of the electric current.

When the zone is heated by induction, the electric current is induced on the surface of the zone to be treated of the rack.

When the zone is heated by conduction, the electric current is transmitted to the surface of the zone to be treated of the rack by two electric electrodes.

In some embodiments, the heating step and the cooling step are carried out simultaneously on two different zones.

In other words, a first zone of the rack is heated while a second zone is cooled. The first zone will then be cooled while a third zone will be heated.

This is a continuous quenching method.

In some embodiments, the zone to be treated corresponds to an entire outer surface to be treated.

In other words, the entire surface to be treated is heated and then cooled. The quenching method is discontinuous.

In some embodiments, the rack is made of steel.

In some embodiments, the rack is a solid bar that is at least partially cylindrical.

Thus, the center of the rack is full of material that is not heated and which cools the zone to be treated by conduction. The cooling step is therefore improved.

Another aspect of the invention concerns a quenching device configured to implement the method according to the invention, the device comprising an inductor configured to induce an electric current in the zone, and a cooler provided with at least one projection nozzle configured to project the first gas flow onto said zone.

In some embodiments, the device also comprises a device for recovering and recycling the projected gases.

In some embodiments, the device also comprises a device for cooling the projected gases.

### BRIEF DESCRIPTION OF THE DRAWINGS

The invention will be better understood, thanks to the following description, which relates to one or more embodiments according to the present invention, given as non-limiting examples and explained with reference to the appended schematic drawings, in which:

FIG. 1 is a theoretical representation of the method according to the invention;

FIG. 2 is a schematic representation of the method when a heating step and a cooling step are carried out simultaneously;

FIG. 3 is a schematic representation of the method when the heating step and the cooling step are carried out one after the other according to a first embodiment;

FIG. 4 is a schematic representation of the method when the heating step and the cooling step are carried out one after the other according to a second embodiment;

### DESCRIPTION OF THE EMBODIMENTS

Only the elements necessary for understanding the invention have been shown. To facilitate reading of the drawings, the same elements bear the same references from one figure to another.

The method 100 according to the invention is a quenching method for a power steering rack 1 of a vehicle.

In certain embodiments, the rack 1 is made of steel, for example a steel of a grade which allows the formation of non-equilibrium constituents (martensite or bainite) without necessarily carrying out the cooling step, that is to say under so-called “natural” cooling conditions.

In some embodiments, the rack 1 is a solid bar that is at least partly cylindrical.

The rack 1 comprises an outer surface to be treated. In other words, an outer surface whose crystalline structure must be modified over a quenching thickness e, which is preferably less than a total thickness of the rack 1.

The quenching method 100 consists in performing a heat treatment which aims to transform the metal of the rack 1 over the quenching thickness e from an austenitic crystalline structure A obtained during a heating step into a martensitic crystalline structure M.

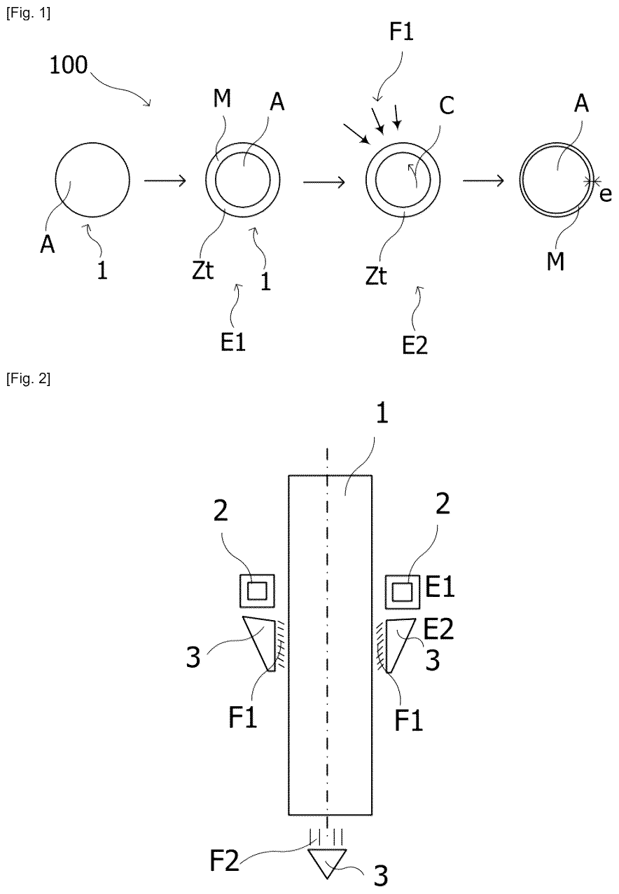

As represented in FIG. 1, the method 100 comprises the heating step E1 in which a zone to be treated Zt of the rack 1 is heated by means of an electric current induced in said zone to be treated Zt. Under the effect of the heat, the zone to be treated Zt takes on an austenitic crystalline structure.

Here, by “induced current” is meant broadly “created current” or “transmitted current” and it is not limited to induction heating. The electric current can be induced by induction or can be induced by conduction as will be explained later.

A temperature reached by the zone to be treated Zt depends on the material of the zone to be treated. With some steels, the temperature of the zone to be treated Zt is higher than 700° C., for example higher than 850° C. or 900° C.

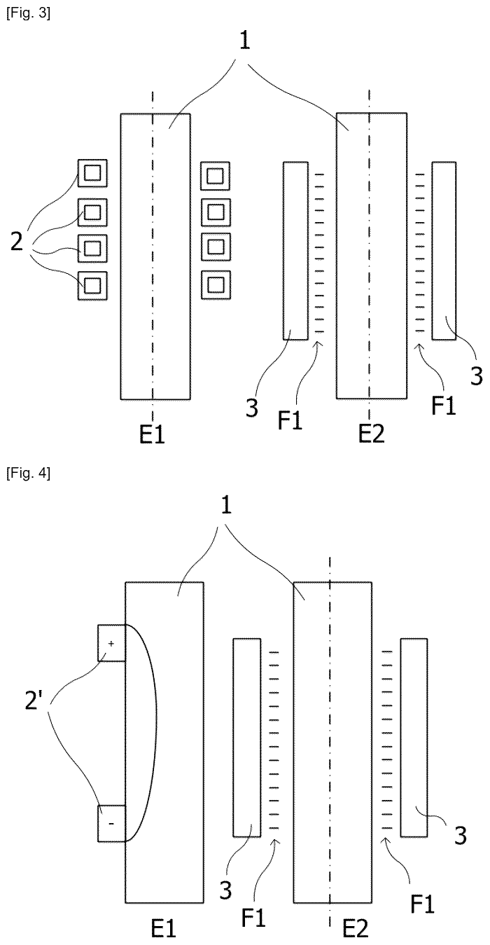

In some embodiments, the at least one zone Zt is heated by induction of the electric current as illustrated in FIGS. 2 and 3, or by conduction of the electric current as illustrated in FIG. 4.

When the zone is heated by induction, the electric current is induced on the surface of the zone to be treated Zt of the rack 1 by an inductor 2.

When the zone is heated by conduction, the electric current is transmitted to the surface of the zone to be treated Zt of the rack 1 by two electric electrodes 2′.

During the heating step, an internal part of the rack 1, that is to say the part comprised between the quenching thickness e and a center of the rack 1, is not quenched, in other words, its crystalline structure is not modified. The internal part compresses the treated zone Zt so as to create compressive stresses which improve a fatigue resistance of the rack 1.

The method 100 comprises, following the heating step E1, a cooling step E2. The cooling step E2 consists in reducing the temperature of the zone Zt so as to transform the austenitic crystalline structure obtained during the heating step E1 into a martensitic structure M. To do this, a cooling rate of the zone Zt must be at least equal to a martensitic critical rate. The martensitic critical rate is determined in the laboratory according to the material and more particularly according to the grade of the steel of the rack.

In the cooling step E2, the at least one zone Zt is cooled by means of at least one first gas flow F1 projected onto said zone Zt.

The method 100 is innovative in that the cooling is performed by means of a first gas flow F1 projected onto the zone Zt. In other words, the gas flow F1 is voluntarily directed at a determined flow rate, temperature and pressure onto the zone Zt. The first gas flow F1 is an artificially created flow to cool the zone Zt.

Indeed, the applicant has found that it is possible to obtain, contrary to what is commonly accepted, a martensitic structure M by cooling with a gas, that is to say with a fluid having a drasticity lower than that of water, for the quenching thickness commonly accepted for the racks, for example a few millimeters.

The drasticity corresponds to the cooling power of the fluid, that is to say an ability of the fluid to evacuate calories from a metal.

In some embodiments, at least one second gas flow F2 is projected onto one end of the rack 1.

The second gas flow F2 allows constant cooling of the rack 1 as illustrated in FIG. 2, and in particular of the center of the rack. The cooling step E2 is improved.

In addition, the center of the rack 1 being full of material that is not heated, the center cools the zone to be treated Zt by conduction C.

In some embodiments, an outlet pressure of a nozzle 3 for projecting the first F1 and/or second F2 gas flow is greater than or equal to 1 bar, for example greater than 5 bar or 20 bar.

Thus the gas flow F1, F2 is projected under pressure so as to improve the drasticity of the gas and therefore the efficiency of the cooling step.

In some embodiments, the gas of the first F1 or second F2 gas flow is air, and/or at least one neutral gas.

The first F1 or second F2 gas flow can therefore also be a mixture of air and neutral gases, or a mixture of neutral gases.

Using air allows a particularly inexpensive and environmentally friendly cooling step E2 in that the air does not need to be cooled, recycled or depolluted.

Using a neutral gas also allows an improvement in the drasticity of the gas.

For example, the neutral gas can be selected from: nitrogen, helium, argon.

Of course, the use of neutral gas requires use of a containment, not represented, in order not to pollute and make toxic the environment in which the quenching method is carried out, and in order to recycle said neutral gas.

Using a gas during the cooling step E2 allows a slower cooling than with water. Stresses exerted in the rack 1 during the cooling step E2 are therefore reduced as well as resulting deformations and cracks.

The method 100 according to the invention is therefore less expensive than that of the state of the art in that it reduces the non-compliant racks 1 due to the presence of excessive deformations or cracks.

Furthermore, the method 100 according to the invention does not require the use of water, which will be partly evaporated, and which must be decontaminated and cooled, and of additives which can be partly burned when brought into contact with the hot rack and thus create potentially toxic fumes.

Finally, the use of gas makes it possible to avoid pollution of the heating elements, such as inductors 2, leading to their degradation and replacement.

Another aspect of the invention concerns a quenching device configured to implement the method 100, the device comprises an inductor 2 configured to induce the electric current in the zone Zt, and a cooler provided with at least one projection nozzle 3 configured to project the first gas flow F1 onto said zone Zt.

In some embodiments, as illustrated in FIG. 2, the device is configured so that the heating step E1 is carried out simultaneously with the cooling step E2 on two different zones of the rack 1.

In other words, a first zone of the rack 1 is heated while a second zone is cooled. The first zone will then be cooled while a third zone will be heated.

This is a continuous, or in-line, quenching method.

In some embodiments, as illustrated in FIGS. 3 and 4, the zone to be treated Zt corresponds to an entire outer surface to be treated. Thus, the zone to be treated Zt is heated firstly and then secondly the zone to be treated Zt is cooled. The quenching method is then discontinuous.

In some embodiments, the device also comprises a device for recovering and recycling the projected gases.

In some embodiments, the device also comprises a device for cooling the projected gases.

Although the present invention has been described with reference to specific embodiments, it is obvious that modifications and changes may be made to these examples without departing from the general scope of the invention as defined by the claims. In particular, individual characteristics of the various illustrated/mentioned embodiments may be combined in additional embodiments. Therefore, the description and drawings are to be considered in an illustrative rather than restrictive sense.

It is also obvious that all the characteristics described with reference to a method are transposable, alone or in combination, to a device, and conversely, all the characteristics described with reference to a device are transposable, alone or in combination, to a method.

1-10. (canceled)

11. A quenching method for a power steering rack of a vehicle, the method comprising:
a heating step in which at least one zone to be treated of an outer surface of the rack is heated by means of an electric current induced in the zone;
wherein the method comprises:
a cooling step in which the at least one zone is cooled by means of at least one first gas flow projected onto said zone.

12. The quenching method according to claim 11, wherein at least one second gas flow is projected onto one end of the rack.

13. The quenching method according to claim 11, wherein an outlet pressure of a nozzle for projecting the first and/or second gas flow is comprised between 0.5 bar and 30 bar.

14. The quenching method according to claim 11, wherein the gas of the first or second gas flow is air, and/or at least one neutral gas.

15. The quenching method according to claim 11, wherein, during the heating step, the at least one zone is heated by induction of the electric current or by conduction of the electric current.

16. The quenching method according to claim 11, wherein the heating step and the cooling step are carried out simultaneously on two different zones.

17. The quenching method according to claim 11, wherein the zone to be treated corresponds to an entire outer surface to be treated.

18. The quenching method according to claim 11, wherein the rack is made of steel.

19. The quenching method according to claim 11, wherein the rack is a solid bar that is at least partly cylindrical.

20. A quenching device configured to implement the method according to claim 11, the device comprising an inductor configured to induce an electric current in the zone, and a cooler provided with at least one projection nozzle configured to project the first gas flow onto the zone.
